(19) United States
(12) Patent Application Publication
(10) Pub. No.: US 2022/0052865 A1
(43) Pub. Date: Feb. 17, 2022

(54) INTERACTION CONTROL METHOD FOR SMART HOME BASED ON SMART SCREEN, DEVICE AND SMART SCREEN

(71) Applicant: SHENZHEN CHUANGWEI-RGB ELECTRONICS CO., LTD., SHENZHEN (CN)

(72) Inventor: Ting ZHU, SHENZHEN (CN)

(73) Assignee: SHENZHEN CHUANGWEI-RGB ELECTRONICS CO., LTD., SHENZHEN (CN)

(21) Appl. No.: 17/253,975

(22) PCT Filed: Oct. 30, 2020
(86) PCT No.: PCT/CN2020/125542

§ 371 Date: Jul. 21, 2021

(30) Foreign Application Priority Data
Apr. 2, 2020 (CN) 202010256059.2

(51) Int. Cl. H04L 12/28; G05B 15/02

(52) U.S. Cl. CPC H04L 12/282; G05B 15/02; H04L 2012/285; H04L 2012/2841; H04L 12/2825

(57) ABSTRACT

Provided are an intelligent screen and a method and an apparatus for interactive control of smart home appliances based on an intelligent screen. The intelligent screen is provided with a communication contact which is configured to contact and communicate with one of smart home devices provided with corresponding contacts. The method includes: obtaining access information from a first smart home device establishing a communication control relationship via the communication contact, when the current application state of the communication contact is changed from an idle state to an active state; determining whether the intelligent screen is occupied by another application interface in the idle state; if yes, exiting the another application interface and then displaying a corresponding first control interface according to the access information; exiting the first control interface and then restoring the another application interface when the application state is changed from the active state to the idle state.

### CROSS-REFERENCE TO RELATED APPLICATIONS

The present disclosure claims priority to Chinese Patent Application No. 2020102560592, filed with the Chinese Patent Office on Apr. 2, 2020, entitled “Interaction Control Method for Smart Home Based on Smart Screen, Device and Smart Screen”, which is incorporated herein by reference in its entirety.

### TECHNICAL FIELD

The present disclosure relates to the field of smart homes, and in particular to a method and apparatus for interactive control of smart home appliances based on an intelligent screen and an intelligent screen (or an interaction control method for smart home based on smart screen, device and smart screen).

### BACKGROUND ART

With the development of AIOT and the upgrading of display technologies, visualized interactive intelligent screens will become the main interaction means for intelligent homes in the future. With the development of display technologies and people's demand for information visualization, many household appliances are provided with display screens to display the current states of the household appliances in real time. This meets people's demand for directly obtaining information on household appliances at any time. However, on the other hand, display screens of many household appliances are utilized at a very low rate. For example, display screens on washing machines are used by people only during washing to control the washing machines via the display screens. Display screens of dishwashers are used by people only during dishwashing to control the dishwashers via the display screens.

Currently, it is not uncommon to use a smart phone or a tablet computer to control smart home appliances. Usually, a chip for controlling smart home appliances or an application for controlling smart home appliances is installed on a smart phone or on a tablet computer, whereby the user is enabled to control the smart home appliances via the smart phone or the tablet computer. The corresponding operation method is performed by: turning on the screen of the mobile phone or the tablet computer→unlocking→opening the application for controlling smart home appliances→pairing and connecting a smart home appliance→controlling the smart home appliance, wherein the successfully paired and connected smart home appliances are displayed on the screen of the smart phone in the form of a list. Then, the user selects a smart home appliance to be controlled from the list. After the smart home appliance to be controlled is selected, a corresponding control interface is displayed to enable the control of the smart home appliance. Although the method of controlling smart home appliances using a smart phone or a tablet computer in the prior art provides a new option for a user to control smart home appliances, the operation method are too cumbersome.

### SUMMARY

In view of the foregoing problems, the present disclosure provides an intelligent screen and a method and apparatus for interactive control of smart home appliances based on an intelligent screen.

An embodiment of the present disclosure proposes a method for interactive control of smart home appliances based on an intelligent screen. The intelligent screen is provided with a communication contact which is configured to be in contact communication with one of smart home devices provided with corresponding contacts. The method includes:

obtaining access information from a first smart home device that establishes a communication control relationship via the communication contact, when the current application state of the communication contact is changed from an idle state to an active state;

determining whether the intelligent screen is occupied by another application interface in the idle state, and exiting, if it is occupied, the another application interface and then displaying a corresponding first control interface according to the access information; and

exiting the first control interface and then restoring the another application interface when the application state is changed from the active state to the idle state.

In a possible implementation, the method further includes:

directly displaying the corresponding first control interface according to the access information when the intelligent screen is not occupied by another application interface in the idle state.

In a possible implementation, before the obtaining access information from a first smart home device that establishes a communication control relationship via the communication contact when the current application state of the communication contact is changed from an idle state to an active state, the method further includes:

determining whether there is contact communication between the communication contact of the intelligent screen and one of the smart home devices provided with corresponding contacts, wherein

the application state of the communication contact of the intelligent screen is in an active state if there is contact communication therebetween; and

the application state of the communication contact of the intelligent screen is in an idle state if there is no contact communication therebetween.

In a possible implementation, the method for interactive control of smart home appliances based on an intelligent screen described above further includes:

generating a corresponding request message to wait for user's confirmation, if a request for displaying a corresponding second control interface is received from a second smart home device in a wireless communication mode, when the communication contact is in the active state;

exiting the first control interface and displaying the second control interface, if a user's confirmation command to enter the second control interface is obtained; and

exiting the second control interface and then restoring the first control interface when a command to end the corresponding operation of the second control interface is received.

In a possible implementation, the method further includes:

keeping displaying the first control interface when a user's confirmation command to enter the second control interface is not obtained.

In a possible implementation, the command to end the operation includes an exit command given by a user's voice signal and/or an exit command given by touch and/or an exit command given by pressing a button.

In a possible implementation, the above-mentioned wireless communication mode includes: a ZigBee communication mode and/or a WIFI communication mode and/or a Bluetooth communication mode and/or an infrared sensing communication mode.

In a possible implementation, the above-mentioned request message includes: a voice request message and/or a text request message.

In a possible implementation, the above-mentioned user's confirmation command includes a voice signal command and/or a touch command and/or a button command.

In a possible implementation, the method for interactive control of smart home appliances based on an intelligent screen described above further includes: obtaining electrical energy for operation from the first smart home device via the communication contact.

In a possible implementation, the method for interactive control of smart home appliances based on an intelligent screen described above further includes: writing initial configuration information into the first smart home device via the communication contact.

Another embodiment of the present disclosure proposes an apparatus for interactive control of smart home appliances based on an intelligent screen. The intelligent screen is provided with a communication contact which is configured to contact and communicate with one of smart home devices provided with corresponding contacts. The apparatus includes:

an obtaining module, configured to obtain access information from a first smart home device that establishes a communication control relationship via the communication contact, when the current application state of the communication contact is changed from an idle state to an active state;

an execution module, configured to determine whether the intelligent screen is occupied by another application interface in the idle state, and exit, if it is occupied, the another application interface and then display a corresponding first control interface according to the access information; and

a restoring module, configured to exit the first control interface and then restore the another application interface when the application state is changed from the active state to the idle state.

Yet another embodiment of the present disclosure proposes an intelligent screen, comprising a memory and a processor. The memory is configured to store a computer program. The computer program is run by the processor to cause the intelligent screen to execute the method for interactive control of smart home appliances based on an intelligent screen described above.

A further embodiment of the present disclosure proposes a readable storage medium storing a computer program. The computer program executes the method for interactive control of smart home appliances based on an intelligent screen described above when running on a processor.

In the technical solution of the present disclosure, the communication contact of the intelligent screen contacts and communicates with a smart home device provided with a corresponding contact, to establish a communication control relationship. The intelligent screen according to the present disclosure can be used for controlling multiple smart home devices provided with corresponding contacts. It is determined whether to display a corresponding control interface according to the application state of the communication contact of the intelligent screen. An embodiment of the solution includes at least the following advantageous effects. There is no need to provide a display screen with specific functions for each smart home device, and the communication contact of the intelligent screen can contact and communicate with any of smart home devices provided with corresponding contacts, to establish a communication control relationship. Moreover, smart home devices can be controlled by using the intelligent screen by simply contacting the communication contact of the intelligent screen with the smart home devices provided with corresponding contacts. The control process is performed more simply and conveniently, thereby avoiding a cumbersome control process performed by turning on a screen of a mobile terminal→unlocking→opening an application for controlling smart home appliances→pairing and connecting a smart home appliance→controlling the smart home appliance.

### BRIEF DESCRIPTION OF THE DRAWINGS

In order to more clearly illustrate the technical solutions of the present disclosure, drawings required for use in the embodiments will be described briefly below. It is to be understood that the drawings below are merely illustrative of some embodiments of the present disclosure, and therefore should not be considered as limiting its scope. In the figures, similar components are denoted by similar reference numerals.

FIG. 1 shows a schematic flowchart of a smart interactive control method based on an intelligent screen (a method for interactive control of smart home appliances based on an intelligent screen) in an embodiment of the present disclosure;

FIG. 2 shows a schematic flowchart of another smart interactive control method based on an intelligent screen (another method for interactive control of smart home appliances based on an intelligent screen) in an embodiment of the present disclosure; and

FIG. 3 shows a schematic structural view of a smart interactive control apparatus based on an intelligent screen (an apparatus for interactive control of smart home appliances based on an intelligent screen) in an embodiment of the present disclosure.

### DESCRIPTION OF REFERENCE NUMERALS OF MAIN ELEMENTS

1—apparatus for interactive control of smart home appliances based on an intelligent screen; 100—obtaining module; 200—execution module; 300—restoring module.

### DETAILED DESCRIPTION OF THE EMBODIMENTS

The technical solutions of the embodiments of the present disclosure will be described below clearly and completely with reference to the accompanying drawings of the embodiments of the present disclosure. It is apparent that the embodiments to be described are some, but not all of the embodiments of the present disclosure.

Generally, the components of the embodiments of the present disclosure, as described and illustrated in the figures herein, may be arranged and designed in a wide variety of different configurations. Thus, the following detailed description of the embodiments of the present disclosure, as represented in the figures, is not intended to limit the scope of the present disclosure as claimed, but is merely representative of selected embodiments of the present disclosure. All the other embodiments obtained by those of ordinary skill in the art in light of the embodiments of the present disclosure without inventive efforts will fall within the scope of the present disclosure as claimed.

Hereinafter, the terms “comprising”, “including”, “having”, and their cognates as used in various embodiments of the present disclosure are merely intended to indicate specific features, numbers, steps, operations, elements, components or combinations of the foregoing items, and should not be construed as precluding the possibility of the presence of one or more other features, numbers, steps, operations, elements, components or combinations of the foregoing items or the addition of one or more features, numbers, steps, operations, elements, components or combinations of the foregoing items.

In addition, the terms such as “first”, “second”, and “third” are used for distinguishing the description only, and should not be understood as an indication or implication of relative importance.

Unless otherwise defined, all terms (including technical and scientific terms) used herein have the same meanings as commonly understood by those of ordinary skill in the art to which the various embodiments of the present disclosure pertain. The terms (such as those defined in commonly used dictionaries) should be interpreted as having the same meanings as those in the context of the relevant art and will not be interpreted in an idealized or overly formal sense unless expressly so defined in the various embodiments of the present disclosure.

An intelligent screen disclosed in an embodiment of the present disclosure may be provided with a communication contact at a specific position. The communication contact may be configured to contact and communicate with one of smart home devices provided with corresponding contacts. Optionally, the intelligent screen with a communication contact may be attached to any smart home device provided with a corresponding contact via the communication contact, and then the smart home device may be controlled via the intelligent screen.

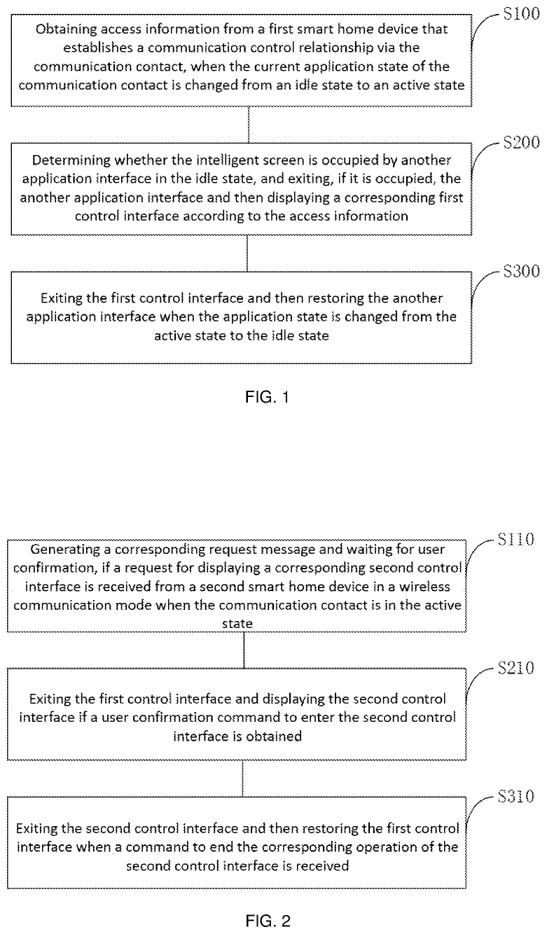

Referring to FIG. 1, an embodiment of the present disclosure shows a schematic flowchart of a method for interactive control of smart home appliances based on an intelligent screen. As shown in FIG. 1, the method for interactive control of smart home appliances based on an intelligent screen may include the following steps.

In step S100, when the current application state of the communication contact is changed from an idle state to an active state, access information is obtained from a first smart home device that establishes a communication control relationship via the communication contact.

It should be understood that the application state of the communication contact of the intelligent screen is an active (or non-idle) state after the communication contact of the intelligent screen contacts and communicates with one of smart home devices provided with corresponding contacts, and the application state of the communication contact of the intelligent screen is an idle state if the communication contact of the intelligent screen does not contact with any smart home device. In other words, it may be determined before step S100 whether there is contact communication between the communication contact of the intelligent screen and one of the smart home devices provided with corresponding contacts. If there is contact communication therebetween, the application state of the communication contact of the intelligent screen is the active state. If there is no contact communication therebetween, the application state of the communication contact of the intelligent screen is the idle state.

Optionally, when the user brings the communication contact of the intelligent screen into contact with a smart home device provided with a corresponding contact (the smart home device may be regarded as a first smart home device in the embodiment of the present disclosure), the application state of the communication contact of the intelligent screen is changed from the idle state to the active state, and the intelligent screen may control the first smart home device in contact therewith via the communication contact and obtain access information from the first smart home device. Optionally, the access information may be model information, location information, function information, basic application information, and other information of the first smart home device.

In step S200, it is determined whether the intelligent screen is occupied by another application interface in the idle state, and if it is occupied, another application interface is exited and then a corresponding first control interface is displayed according to the access information.

In some possible embodiments, it may be determined whether the intelligent screen is occupied by another application interface in the idle state before the intelligent screen is in contact with the first smart home device. If a certain application is being used on the intelligent screen in the idle state, the display interface of the intelligent screen is occupied by this application interface. At this time, if the application state of the communication contact of the intelligent screen is changed from the idle state to the active state, the application interface in the idle state is exited and then a corresponding first control interface is displayed according to the access information from the first smart home device.

In some possible embodiments, if the intelligent screen does not use any application program when the communication contact of the intelligent screen is in the idle state, the display interface of the intelligent screen may be in a state where the screen is turned off or in a state where the screen is locked. At this time, if the application state of the communication contact of the intelligent screen is changed from the idle state to the active state, the intelligent screen may directly display the corresponding first control interface according to the access information from the first smart home device.

In step S300, when the application state is changed from the active state to the idle state, the first control interface is exited and then another application interface is restored.

Optionally, when the user removes the intelligent screen from the first smart home device in contact therewith, the application state of the communication contact of the intelligent screen is changed from the active state to the idle state. At this time, the first control interface for controlling the first smart home device displayed on the intelligent screen is exited, and then the application interface before contacting with the first smart home device is restored.

In the technical solution disclosed in the embodiment of the present disclosure, the communication contact of the intelligent screen contacts and communicates with a smart home device provided with a corresponding contact to establish a communication control relationship. The intelligent screen according to the embodiment of the present disclosure can be used for controlling multiple smart home devices. On the one hand, there is no need to provide a display screen with specific functions for each smart home device. On the other hand, smart home devices can be controlled by using the intelligent screen by simply contacting the communication contact of the intelligent screen with the smart home devices provided with corresponding contacts. The control process is performed more simply and conveniently, thereby avoiding a cumbersome control process performed by turning on a screen of a mobile terminal→unlocking→opening an application for controlling smart home appliances→pairing and connecting a smart home appliance→controlling the smart home appliance.

Referring to FIG. 2, an embodiment of the present disclosure shows another method for interactive control of smart home appliances based on an intelligent screen. As shown in FIG. 2, another method for interactive control of smart home appliances based on an intelligent screen may include the following steps.

In step S110, when the communication contact is in the active state, if a request for displaying a corresponding second control interface is received from a second smart home device in a wireless communication mode, a corresponding request message is generated and user's confirmation is awaited.

In some possible embodiments, when the intelligent screen is attached to a first smart home device provided with a corresponding contact via the communication contact, the intelligent screen may establish a communication control relationship with the first smart home device via the communication contact, and the user may control the first smart home device via the first control interface displayed on the intelligent screen. In other possible embodiments, other smart home devices in the smart home appliances may be connected to the intelligent screen in a wireless communication mode. Accordingly, the intelligent screen may receive information from other smart home devices in a wireless communication mode.

In some possible embodiments, if the intelligent screen receives a request for displaying a corresponding second control interface from a second smart home device in a wireless communication mode when the user is controlling the first smart home device via the first control interface displayed on the intelligent screen, a corresponding request message will be generated on the intelligent screen, and user's confirmation is awaited.

Optionally, the above-mentioned wireless communication mode may include: a ZigBee communication mode and/or a WIFI communication mode and/or a Bluetooth communication mode and/or an infrared sensing communication mode.

In some possible embodiments, the above-mentioned request message may include: a voice request message and/or a text request message. Optionally, the intelligent screen may notify the user by voice, or notify the user by popping up a corresponding text message.

In step S210, if a confirmation command to enter the second control interface is obtained from the user, the first control interface is exited and the second control interface is displayed.

In some possible embodiments, if a voice signal command and/or a touch command and/or a button command for confirming entry into the second control interface is obtained from the user, the first control interface is exited and the second control interface is displayed. In other possible embodiments, if the user does not send a confirmation command, the intelligent screen ignores the request for displaying the corresponding second control interface from the second smart home device, and the first control interface is kept being displayed on the display interface of the intelligent screen.

In step S310, when a command to end the corresponding operation of the second control interface is received, the second control interface is exited and then the first control interface is restored.

Here, when the intelligent screen receives a command to end the corresponding operation of the second control interface, the second control interface is exited, and then the first control interface is restored. It should be understood that, in some possible embodiments, the command to end the corresponding operation of the second control interface may include an exit command given by a user's voice signal and/or an exit command given by touch and/or an exit command given by pressing a button. In other possible embodiments, the command to end the corresponding operation of the second control interface may further include: allowing the intelligent screen to automatically exit the second control interface and then restore the first control interface after the corresponding operation of the second control interface is ended.

In some possible embodiments, when the intelligent screen is attached to a range hood, the intelligent screen establishes a communication control relationship with the range hood via the communication contact, and the user may control the range hood via a control interface displayed on the intelligent screen, or watch a related recipe tutorial. Optionally, a smart door lock system may send a visitor notification to the intelligent screen by means of WIFI communication and make a request for displaying a second control interface corresponding to the smart door lock system. The intelligent screen generates a corresponding request message and waits for user's confirmation. If the user confirms the display of visitor information by voice, the intelligent screen controls exiting the control interface corresponding to the range hood, and the intelligent screen displays the visitor information. The user may control the intelligent screen by voice according to the visitor information, to execute a corresponding command to open the door or a command to reject the visitor. When the user's command is completed, the intelligent screen may receive a command to end the corresponding operation of the second control interface corresponding to the smart door lock system, and the display interface of the intelligent screen exits the second control interface and is then restored to the first control interface displayed before the second interface is displayed.

In the embodiment of the present disclosure, interactive control of various smart home devices is implemented by using the intelligent screen. The control process is performed more simply and flexibly, thereby simplifying the prior art cumbersome processes of controlling smart home devices and facilitating improved user experience.

Optionally, the intelligent screen may obtain electrical energy for operation from the first smart home device in contact therewith via the above-mentioned communication contact. It should be understood that, in this charging mode, there is no need to provide the intelligent screen with a separate charging interface and with a corresponding charging device. Once the intelligent screen is in contact with any of smart home devices provided with corresponding contacts, the intelligent screen can obtain electrical energy for operation from the smart home device in contact therewith. This charging mode is simple and convenient and facilitates improved user experience.

Optionally, the intelligent screen may write (record) initial configuration information into the first smart home device via the above-mentioned communication contact. In some possible embodiments, when the user purchases a refrigerator provided with a corresponding contact, the wifi account information and password may be written into this refrigerator by only contacting the communication contact of the intelligent screen with the contact of the refrigerator by the user. Pairing information about Bluetooth pairing with the intelligent screen may also be written into the refrigerator. Initial configuration information can be written into a smart home device in contact therewith via the communication contact, thereby simplifying a cumbersome operation of searching for a device and writing an account and a password into the device by the user.

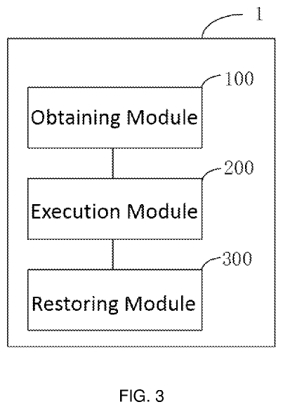

Referring to FIG. 3, an embodiment of the present disclosure shows an apparatus 1 for interactive control of smart home appliances based on an intelligent screen. The apparatus may include the following modules.

An obtaining module 100 is configured to obtain access information from a first smart home device that establishes a communication control relationship via the communication contact, when the current application state of the communication contact is changed from an idle state to an active state.

An execution module 200 is configured to determine whether the intelligent screen is occupied by another application interface in the idle state, and exit, if it is occupied, the another application interface and then display a corresponding first control interface according to the access information.

A restoring module 300 is configured to exit the first control interface and then restore another application interface when the application state is changed from the active state to the idle state.

The apparatus 1 for interactive control of smart home appliances based on an intelligent screen according to the embodiment of the present disclosure is configured to execute the method for interactive control of smart home appliances based on an intelligent screen described in the foregoing embodiment by the cooperative use of the obtaining module 100, the execution module 200, and the restoring module 300. The implementable solutions and advantageous effects involved in the foregoing embodiment are also applicable to this embodiment of the present disclosure and will not be described in detail here.

It should be understood that the intelligent screen described in the foregoing embodiment includes a memory and a processor. The memory is configured to store a computer program. The computer program is run by the processor to cause the intelligent screen to execute the method for interactive control of smart home appliances based on an intelligent screen described in the foregoing embodiment.

In several embodiments according to the present disclosure, it should be understood that the disclosed apparatus and method may also be implemented in other ways. The embodiment of the apparatus described above is merely illustrative in nature. For example, the flow charts and block diagrams in the figures illustrate implementable architectures, functionalities, and operations of apparatuses, methods, and computer program products according to multiple embodiments of the present disclosure. In this regard, each block in the flow charts or block diagrams may represent a module, a program segment, or a portion of code, wherein the module, the program segment, or the portion of code includes one or more executable instructions for implementing specified logical function(s). It should also be noted that in some alternative implementations, the functions noted in the blocks may occur out of the order noted in the figures. For example, two blocks shown in succession may in fact be executed substantially concurrently, or they may sometimes be executed in a reverse order, depending upon the functionality involved. It will also be noted that each block of the block diagrams and/or flow charts, and combinations of blocks in the block diagrams and/or flow charts, may be implemented by special purpose hardware-based systems that execute the specified functions or actions, or by a combination of special purpose hardware and computer instructions.

Besides, the individual functional modules or units in the embodiments of the present disclosure may be integrated together to form an independent part, or each of the modules may be physically stand-alone, or two or more of the modules may be integrated into an independent part.

When implemented in the form of a software functional module and sold or used as an independent product, the functions may be stored in a computer-readable storage medium. Based on such understanding, a technical solution of the present disclosure essentially, or the part thereof contributing to the prior art, or a part of the technical solution may be embodied in the form of a software product. The computer software product is stored in a storage medium and includes a number of instructions for causing a computer device (which may be a smart phone, a personal computer, a server, a network device, or the like) to execute all or some of the steps of the methods described in the various embodiments of the present disclosure. The preceding storage medium includes any medium that can store program codes, such as a USB flash disk, a mobile hard disk, a read-only memory (ROM), a random access memory (RAM), a magnetic disk, or an optical disk.

Although specific embodiments of the present disclosure are described above, the scope of protection of the present disclosure is not limited thereto. Any variations or alternatives that can be readily envisaged by those skilled in the art are intended to be encompassed within the scope of protection of the present disclosure.

### INDUSTRIAL APPLICABILITY

In the technical solution of an embodiment of the present disclosure, the communication contact of the intelligent screen contacts and communicates with a smart home device provided with a corresponding contact to establish a communication control relationship. The intelligent screen according to an embodiment of the present disclosure can be used for controlling multiple smart home devices provided with corresponding contacts. It is determined whether to display a corresponding control interface according to the application state of the communication contact of the intelligent screen. An embodiment of the solution includes at least the following advantageous effects. There is no need to provide a display screen with specific functions for each smart home device, and the communication contact of the intelligent screen can contact and communicate with any of smart home devices provided with corresponding contacts to establish a communication control relationship. Moreover, smart home devices can be controlled by using the intelligent screen by simply contacting the communication contact of the intelligent screen with the smart home devices provided with corresponding contacts. The control process is performed more simply and conveniently, thereby avoiding a cumbersome control process performed by turning on a screen of a mobile terminal→unlocking→opening an application for controlling smart home appliances→pairing and connecting a smart home appliance→controlling the smart home appliance.

1. A method for interactive control of smart home appliances based on an intelligent screen, wherein the intelligent screen is provided with a communication contact, wherein the communication contact is configured to be in contact communication with one of smart home devices provided with corresponding contacts, wherein the method comprises:
obtaining access information from a first smart home device that establishes a communication control relationship via the communication contact, when a current application state of the communication contact is changed from an idle state to an active state;
determining whether the intelligent screen is occupied by another application interface in the idle state, and exiting, if the intelligent screen is occupied, the another application interface and then displaying a corresponding first control interface according to the access information; and
exiting the first control interface and then restoring the another application interface, when the application state is changed from the active state to the idle state.

2. The method for interactive control of smart home appliances based on an intelligent screen according to claim 1, wherein the method further comprises:
directly displaying the corresponding first control interface according to the access information, when the intelligent screen is not occupied by another application interface in the idle state.

3. The method for interactive control of smart home appliances based on an intelligent screen according to claim 1, wherein before the obtaining access information from a first smart home device that establishes a communication control relationship via the communication contact, when a current application state of the communication contact is changed from an idle state to an active state, the method further comprises:
determining whether the communication contact of the intelligent screen is in contact communication with one of the smart home devices provided with corresponding contacts, wherein
the application state of the communication contact of the intelligent screen is in an active state if being in contact communication therebetween; and
the application state of the communication contact of the intelligent screen is in an idle state if not being in contact communication therebetween.

4. The method for interactive control of smart home appliances based on an intelligent screen according to claim 1, further comprising:
generating a corresponding request message and waiting for a confirmation from a user, if a request for displaying a corresponding second control interface is received from a second smart home device in a wireless communication mode, when the communication contact is in the active state;
exiting the first control interface and displaying the second control interface, if obtaining from the user a confirmation command of entering the second control interface;
exiting the second control interface and then restoring the first control interface, when a command of ending a corresponding operation of the second control interface is received.

5. The method for interactive control of smart home appliances based on an intelligent screen according to claim 4, wherein the method further comprises:
keeping displaying the first control interface, when not obtaining from the user the confirmation command of entering the second control interface.

6. The method for interactive control of smart home appliances based on an intelligent screen according to claim 4, wherein the command to end the operation comprises an exit command in form of a user voice signal and/or an exit command in form of touch and/or an exit command in form of pressing a button.

7. The method for interactive control of smart home appliances based on an intelligent screen according to claim 4, wherein the wireless communication mode comprises: a ZigBee communication mode and/or a WIFI communication mode and/or a Bluetooth communication mode and/or an infrared sensing communication mode.

8. The method for interactive control of smart home appliances based on an intelligent screen according to claim 4, wherein the request message comprises: a voice request message and/or a text request message.

9. The method for interactive control of smart home appliances based on an intelligent screen according to claim 4, wherein the confirmation command, from the user, comprises a voice signal command and/or a touch command and/or a button command.

10. The method for interactive control of smart home appliances based on an intelligent screen according to claim 1, further comprising: obtaining, from the first smart home device, via the communication contact, electrical energy for operation.

11. The method for interactive control of smart home appliances based on an intelligent screen according to claim 1, further comprising: recording initial configuration information into the first smart home device via the communication contact.

12. The method for interactive control of smart home appliances based on an intelligent screen according to claim 1, wherein the access information comprises model information, location information, function information and basic application information about the first smart home device.

13. An apparatus for interactive control of smart home appliances based on an intelligent screen, wherein the intelligent screen is provided with a communication contact, wherein the communication contact is configured to be in contact communication with one of smart home devices provided with corresponding contacts, wherein the apparatus comprises:
an obtaining module, configured to obtain access information from a first smart home device that establishes a communication control relationship via the communication contact, when a current application state of the communication contact is changed from an idle state to an active state;
an execution module, configured to determine whether the intelligent screen is occupied by another application interface in the idle state, and exit, if the intelligent screen is occupied, the another application interface and then display a corresponding first control interface according to the access information; and
a restoring module, configured to exit the first control interface and then restore the another application interface, when the application state is changed from the active state to the idle state.

14. An intelligent screen, comprising a memory and a processor, wherein the memory is configured to store a computer program, and the processor runs the computer program to cause the intelligent screen to execute the method for interactive control of smart home appliances based on an intelligent screen according to claim 1.

15. (canceled)

16. The method for interactive control of smart home appliances based on an intelligent screen according to claim 2, wherein before the obtaining access information from a first smart home device that establishes a communication control relationship via the communication contact, when a current application state of the communication contact is changed from an idle state to an active state, the method further comprises:
determining whether the communication contact of the intelligent screen is in contact communication with one of the smart home devices provided with corresponding contacts, wherein
the application state of the communication contact of the intelligent screen is in an active state if being in contact communication therebetween; and
the application state of the communication contact of the intelligent screen is in an idle state if not being in contact communication therebetween.

17. The method for interactive control of smart home appliances based on an intelligent screen according to claim 2, further comprising:
generating a corresponding request message and waiting for a confirmation from a user, if a request for displaying a corresponding second control interface is received from a second smart home device in a wireless communication mode, when the communication contact is in the active state;
exiting the first control interface and displaying the second control interface, if obtaining from the user a confirmation command of entering the second control interface;
exiting the second control interface and then restoring the first control interface, when a command of ending a corresponding operation of the second control interface is received.

18. The method for interactive control of smart home appliances based on an intelligent screen according to claim 5, wherein the command to end the operation comprises an exit command in form of a user voice signal and/or an exit command in form of touch and/or an exit command in form of pressing a button.

19. The method for interactive control of smart home appliances based on an intelligent screen according to claim 5, wherein the wireless communication mode comprises: a ZigBee communication mode and/or a WIFI communication mode and/or a Bluetooth communication mode and/or an infrared sensing communication mode.

20. The method for interactive control of smart home appliances based on an intelligent screen according to claim 5, wherein the request message comprises: a voice request message and/or a text request message.

21. The method for interactive control of smart home appliances based on an intelligent screen according to claim 5, wherein the confirmation command, from the user, comprises a voice signal command and/or a touch command and/or a button command.
